(19) United States
(12) Patent Application Publication
(10) Pub. No.: US 2006/0248995 A1
(43) Pub. Date: Nov. 9, 2006

(54) Cutting device

(76) Inventors: Wolfgang Schneider, Stuttgart (DE); Hartmut Brodbek, Stuttgart (DE); Wofgang Drefs, Huttlingen (DE)

Correspondence Address: VOITH FABRICS, 3040 BLACK CREEK ROAD, P.O. BOX 1411, WILSON, NC, 27893, US

(21) Appl. No.: 11/409,167

(22) Filed: Apr. 21, 2006

(30) Foreign Application Priority Data
Apr. 22, 2005 (DE) 10 2005 018 769.2

(51) Int. Cl. B26D 7/06

(52) U.S. Cl. 83/78

(57) ABSTRACT

The invention relates to a cutting device having a cutting unit that divides a strip from a material web moving in a transport direction relative to the cutting device, and having a base support that defines a cutting section that supports the material web during the division of the strip, and a supporting section following in the transport direction, which is formed and arranged in such a way that it supports the cut material web and the strip as they are transported away out of the cutting section in the transport direction, wherein the supporting section has, at least in some sections, a transport surface that moves in the transport direction and which is formed and arranged in such a way that the cut material web and/or the strip is/are carried along on the transport surface in the transport direction, at least in some sections.

### CROSS-REFERENCE TO RELATED APPLICATIONS

The present application claims priority under 35 U.S.C. §119 of German Patent Application No. 10 2005 018 769.2 filed on Apr. 22, 2005, the disclosure of which is expressly incorporated by reference herein in its entirety.

### BACKGROUND OF INVENTION

1. Field of the Invention

This invention relates to a cutting device for dividing a strip from a material web moving in a transport direction relative to the cutting device.

2. Discussion of Background Information

Such cutting devices are generally found in machines for producing and/or further processing a material web, in particular a fibrous web such as paper, board or tissue, in order preferably to divide an edge strip running parallel to the longitudinal extent of the material web from the material web. Such cutting devices normally have a cutting unit which, for example, produces a cutting jet which acts on the edge of the material web in order to divide off the edge strip.

During division, the material web must be supported by a base support in order not to be able to escape the cutting force. In such cutting devices, the base support is normally formed in such a way that, after the cutting, the material web and the strip divided off can be carried away from the cutting point in a defined manner supported on said base support. The edge strip divided off is usually separated from the material web after being carried away from the cutting point or even while being carried away from the cutting point and is led into a duct for disposal.

During the division of the strip from the material web, cut material is produced in the region of the cut edge of the material web and the cut edge of the strip, which is partly carried along by said strip and partly deposited on the base support. The deposits of cut material on the base support can lead to disruption to the transport of the cut material web, with the consequence that the material web tears and the production process has to be interrupted.

### SUMMARY OF THE INVENTION

The present invention if for a cutting device in which the probability of transport disruptions of the material web as a result of deposits of cut material on the base support is minimized.

The generic cutting device has a cutting unit for dividing a strip from a material web moving in a transport direction relative to the cutting device and a base support. The base support has a cutting section for supporting the material web during division of the strip.

For the cutting device according to the invention, provision is further made for a transport surface that can be moved relative to the cutting section to be arranged after the cutting section in the transport direction.

As a result of providing the transport surface, which is arranged after the cutting section in the transport direction, a number of advantages can be achieved. Firstly, it is possible for the cut material web and/or the strip divided off to be transported away from the cutting section in a defined supported manner and the deposition of cut material, at least in the region of the transport surface, does not lead to disruptions in the transport of the cut material web, since the cut material web and/or the strip are carried along and supported on the transport surface in the transport direction and thus there is no relative speed between the cut material web and/or the strip and deposits of cut material on the transport surface, which means that the deposits cannot cause any damage to the material web.

Secondly, it is possible for the cut material produced during the cutting of the material web to be transported in a defined manner out of the region of the base support arranged following the cutting section in the transport direction before the cut material has accumulated to such an extent that the cut material impedes the transport of the cut material web and/or the strip. In the last-named case, the cut material web and/or the strip do not necessarily have to be carried along on the transport surface.

The cut material web is preferably guided in a free draw following the cutting device.

According to a preferred embodiment of the invention, the base support has a supporting section arranged after the cutting section in the transport direction which is formed and arranged in such a way that it supports the cut material web and/or the strip as it is transported away from the cutting section in the transport direction, the transport surface being arranged in the region of the supporting section. By means of the supporting section, the cut material web and the strip are supported after cutting, which improves the web guidance.

According to a particularly preferred embodiment of the invention, provision is made for the transport surface to be moved in the transport direction and to be formed and arranged in such a way that the cut material web and/or the strip are carried along on the transport surface in the transport direction, at least in some sections.

In this manner, it is possible for the cut material web and/or the strip divided off to be transported away from the cutting section in a defined supported manner and for the deposition of cut material, at least in the region of the transport surface, not to lead to disruptions in the transport of the cut material web, since the cut material web and/or the strip are carried along supported on the transport surface in the transport direction and thus there is no relative speed between the cut material web and/or the strip and deposits of cut material on the transport surface, which means that the deposits can cause no damage to the material web.

According to a further particularly preferred embodiment of the invention, provision is made for the transport surface to be formed and arranged in such a way that cut material accumulating during the cutting of the material web can be deposited on the transport surface and for the transport surface to be moved in such a way that the cut material is carried away from the region of the interaction with the cut material web and/or the strip. In this case, as already explained above, the cut material produced during the cutting of the material web is transported in a defined manner out of the region of the base support arranged after the cutting section in the transport direction, before the cut material has accumulated to such an extent that the cut material impedes the transport of the cut material web and/or the strip. In this case, the cut material web and/or the strip do not necessarily have to be carried along on the transport surface.

Therefore, in this manner, it is possible for the transport surface to be moved in the transport direction of the material web or counter to the transport direction of the material web or transversely with respect to the transport direction of the material web. This is an expedient in particular when the material web and/or the strip is/are not brought into contact with the transport surface.

The speed of the transport device preferably corresponds substantially to the speed of the material web. This avoids any web jam or web tension and consequent web break arising, for example, during the transfer of the material web and/or the strip from the stationary cutting section to the transport device. Of course, this embodiment can also be used in order to carry away deposits of cut material.

If the transport surface has a speed which is lower than the speed of the material web, this surface preferably consists of a material which provides a low coefficient of friction as the material web and the strip slide over the transport surface. The material is, for example, metal, so that the transport surface can be formed as a metallic transport belt, for example.

Various possible ways of forming the transport surface are conceivable. According to a preferred embodiment of the invention, the transport surface is formed by the circumferential surface of a rotating roll. According to a further alternative refinement of the invention, the transport surface is formed by a circulating transport belt. It is also conceivable for the transport surface to be formed by a roll and subsequently by a transport belt, which are arranged one after the other in the transport direction.

According to a preferred embodiment, the cutting unit comprises means for producing a cutting jet, which is aimed at the material web in the cutting section. The use of a cutting jet has proven to be advantageous in particular when cutting material webs since, in this case, the means which produce the jet, for example a laser or high-pressure water jet device, can be arranged at a great distance from the material web. Furthermore, a particularly accurate cut can be achieved with a cutting jet.

In order to divide a strip from a material web formed as a fibrous web, use is preferably made of a fluid jet, for which reason a fluid jet is advantageously produced by the means. This fluid jet can be formed from a gaseous medium or from a liquid medium or from a combination of a gaseous and a liquid medium.

For other types of material webs, such as for example plastic films or metal foils, for the purpose of division use is made of a light beam, for example a laser beam, for which reason, according to a further embodiment, provision is made for a light beam to be produced by the means.

During the division of the strip, cut material accumulates in the cutting section, which has to be carried away from the cutting section in order to prevent disruptions. If, for example, the cutting jet used is moreover a fluid jet, then this must likewise be carried away from the cutting section. A preferred refinement of the invention therefore provides for the cutting section of the base support to have a jet opening for the passage of the cutting jet after the cutting of the strip from a material web and of part of the cut material.

In order to increase the efficiency of carrying away the cut material and the fluid cutting jet following the division of the strip from the material web, provision can be made for a pipe to be provided in the region of the jet opening on the side of the support base facing away from the material web, said pipe being formed and arranged in such a way that the cutting jet and cut material passing through the jet opening are intercepted by said pipe. The pipe can optionally be under vacuum, so the cutting jet and the cut material are sucked into the pipe.

For reasons of space, it is not possible to arrange the transport surface immediately adjacent to the jet opening. In order in the region between the jet opening and the transport surface as far as possible to prevent disruption to the transport of the cut material web by deposits of cut material in this region of the base support, a preferred embodiment of the invention provides for a cutout to be provided in the base support, to extend in the transport direction between the jet opening and the transport surface and to be arranged and formed in such a way that the cut edge of the cut material web and/or the cut edge of the strip is not supported on the supporting section, at least in some sections, as it is transported away from the cutting section.

According to a further preferred embodiment of the invention, provision is made for the cutout to be formed as an opening in the base support. In this way, the deposition of cut material is reduced further, since the latter can fall through the opening in the supporting section and thus cannot accumulate on the supporting section of the base support.

Provision is preferably made for the cutout formed as an opening to merge into the jet opening and to extend as far as the transport surface. In this way, the deposition of cut material is prevented, starting in the cutting section and as far as the transport surface.

According to a further embodiment of the invention, the supporting section comprises a separation region which is formed to separate the strip divided off from the cut material web. Furthermore, a duct is preferably provided, which is arranged in relation to the separation region such that the separated strip is guided from the separation region into the duct.

One practical refinement of this embodiment provides for the separation region to be formed by the section of the transport belt which is currently being deflected around the leading deflection roller in the transport direction.

Another practical refinement of this embodiment, provides for the separation region to be formed by the part of the roll shell leading in the transport direction.

In order to remove deposits from the transport surface, a development of the invention provides for the transport surface to be assigned a cleaning device, by means of which the transport surface can be cleaned in a position in which no strip and/or no cut material web is being carried on said surface. In practical terms, this means that, for example, the shell of the roll can be cleaned at a position at which the latter is not carrying any material web or that the side of the transport belt carrying the material web and/or the strip can be cleaned at a position, for example a return position, in which no material web and/or strip is being carried on the transport belt.

Other possible refinements of the cleaning device include forming the latter as a doctor and/or brush and/or as a fluid jet cleaning device.

The material web is preferably a fibrous web, in particular paper, board or tissue web.

According to a further embodiment of the invention, provision is made for the transport direction of the material web to be parallel to longitudinal extent of the material web. This makes it possible to divide off from the material web a strip parallel to the longitudinal extent.

The cutting device according to the invention is preferably used in a machine for the production and/or processing of a fibrous web.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a cutting device disclosed by the prior art in a perspective view;

FIG. 2 shows the first embodiment of a cutting device according to the invention in a perspective view; and

FIG. 3 shows a second embodiment of a cutting device according to the invention in a perspective view.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

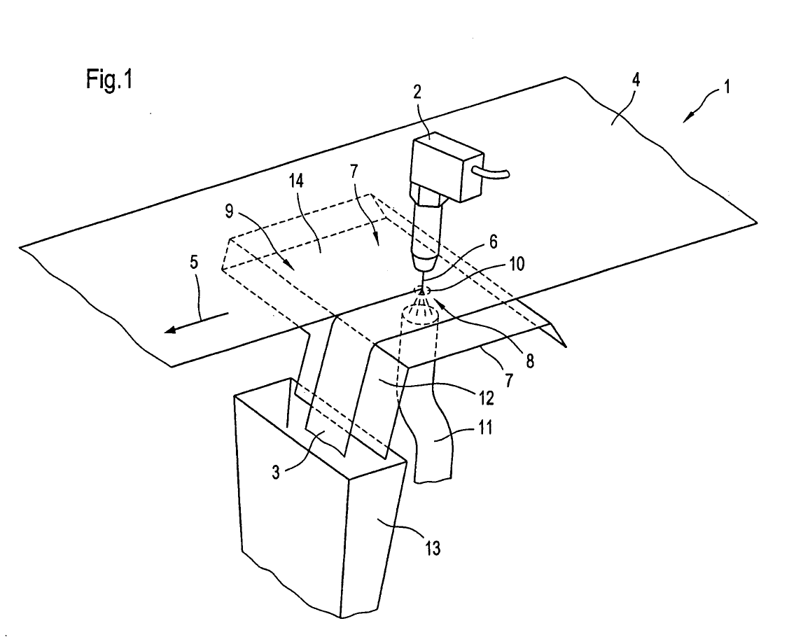

FIG. 1 shows a cutting device 1 disclosed by the prior art. The cutting device 1 has a cutting unit 2 for dividing the strip 3 from a material web 4 moving in a transport direction 5 relative to the cutting device 1. The transport direction 5 of the material web 4 runs parallel to the longitudinal extent of the material web 4.

In the present case, the cutting unit 2 has means for producing a fluid jet 6. Furthermore, the cutting device 1 has a base support 7, which defines the cutting section 8 for supporting the material web 4 during the division of the strip 3, and a supporting section 9, the supporting section 9 being formed and arranged in such a way that it supports the material web 4 and the strip 3 as it is transported away out of the cutting section 8 in the transport direction 5. In practical terms in the present case, this means that the supporting section 9 is arranged after the cutting section 8 in the transport direction 5.

As can be seen from FIG. 1, in the region of the cutting section 8 there is arranged a jet opening 10 for the passage of the cutting jet 6 following the division of the strip 3 from the material web 4. Furthermore, in the region of the jet opening 10, on the side of the base support 7 facing away from the material web 4, a pipe 11 is provided, which is formed and arranged in such a way that the cutting jet 6 and cut material is intercepted by said pipe.

Furthermore, the supporting section 9 comprises a separation region 12, which is formed to separate the strip 3 divided off from the material web 4. The separation region 12 is assigned a duct 13, which is arranged in relation to the separation region 12 in such a way that the separated strip 3 is guided from a separation region 12 into the duct 13. In practical terms, the supporting section 9 comprises a guide region 14, which is arranged before the separation region 12 in the transport direction 5. The guide region 14 runs substantially horizontally, whereas the separation region 12 extends downward at an angle relative to the guide region 14.

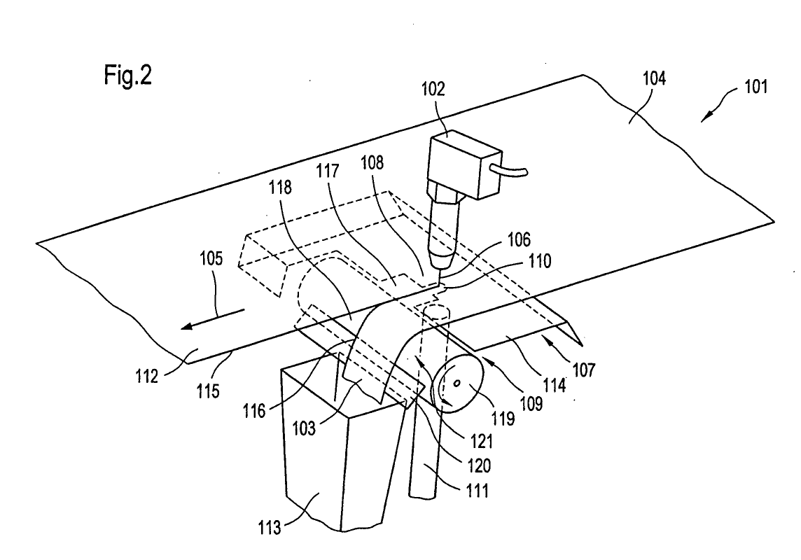

FIG. 2 shows a cutting device 101 according to the invention. The cutting device 101 has a cutting unit 102 for dividing a strip 103 from a material web 104 moving relative to the cutting device 101 in the transport direction 105. In the present case, the cutting unit 102 has means for producing a fluid jet 106. In the present case, the material web 104 is a fibrous web, such as a paper web, the transport direction 105 of the material web 104 running parallel to the longitudinal extent of the material web 104.

The cutting unit 101 has a base support 107, which defines a cutting section 108 for supporting the material web 104 during the division of the strip 103, and a supporting section 109, the supporting section 109 being formed and arranged in such a way that it supports the cut material web 104 and the strip 103 during transport away from the cutting section 108 in the transport direction 105. In practical terms in the present case, this means that the supporting section 109 is arranged after the cutting section 108 in the transport direction 105.

The cutting section 108 has a jet opening 110 for the passage of the cutting jet 106.

Furthermore, in the region of the jet opening 110, as in the known cutting device 1, a pipe 111 is arranged on the side of the base support 107 facing away from the material web 104, 112, said pipe being formed and arranged in such a way that the cutting jet 106 and cut material are intercepted by said pipe.

In the cutting device 101 according to the invention, moreover, the supporting section 109 has a transport surface 118 which moves in the transport direction 105 and is formed by the circumferential surface of a rotating roll 119 and which is formed and arranged in such a way that cut material produced during the cutting is deposited on said surface. Moreover, the transport surface 118 rotates in such a way that the cut material is carried away out of the interaction region with the cut material web 112 and the strip 103, and is taken off the transport surface 118 at a cleaning device 120 formed as a doctor. The removal of cut material takes place at a position on the roll shell 119 at which no material web 112 or strip 103 is being carried on said shell.

In the embodiment illustrated in FIG. 2, the cut material web 112 and the strip 103 are not carried along on the transport surface 118. Instead, the cut material web 112 and the strip slide over the transport surface 118 in contact with the latter. Therefore, the transport surface is formed of a metal in order to provide a low coefficient of friction between the material web 112, the strip 103 and the transport surface 118. In this embodiment, the speed of the transport surface 118 is lower than the speed of the cut material web 112 and of the strip.

In the region between the cutting section 108 and the transport surface 118, the supporting surface 109 is configured as a horizontal plate 114 having a cutout 117 formed as an opening, the opening 117 extending in the transport direction 105 from the jet opening 110 as far as the transport surface 118. In this way, in the region between the jet opening 110 and the transport surface 118, disruptions to the transport of the cut material web 112 by deposits of cut material can be prevented, since the opening 117 is arranged and formed in such a way that the cut edge 115 of the material web 112 and/or the cut edge 116 of the strip 103 is/are not supported on this section of the supporting section 109 as it is transported out of the cutting section 108.

Furthermore, the transport surface 118 formed as a roll shell is assigned a duct 113, which is arranged relative to the roll shell 119 in such a way that the strip 103 is fed to the duct from the transport surface 118. As can be seen from FIG. 2, in this case the strip 103 divided off is deflected downward by the part of the roll shell 119 currently located in the lead in the transport direction 105 and is thus separated from the cut material web 112 and deflected toward the duct 113 whereas the cut material web 112 is carried onward in the original transport direction 105.

The part of the roll shell 119 currently leading in the transport direction 105 during the rotation of the roll 119 therefore forms the separation region 121.

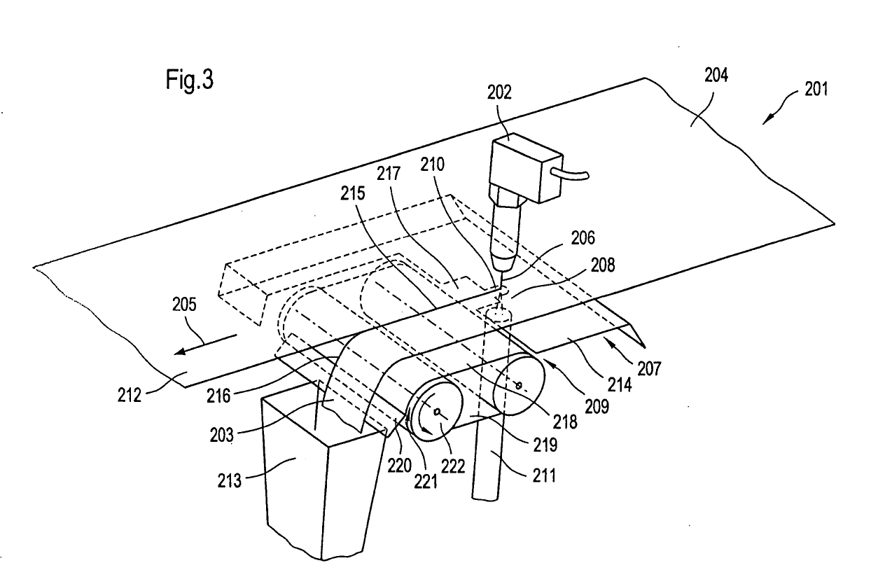

FIG. 3 shows a further cutting device 201 according to the invention. The cutting device 201 has a cutting unit 202 for dividing a strip 203 from a material web 204 moving relative to the cutting direction 201 in a transport direction 205. In the present case, the cutting unit 202 has means for producing a fluid jet 206. In the present case, the material web is a fibrous web, such as a paper web, the transport direction 205 of the material web 204 running parallel to the longitudinal extent of the material web 204.

The cutting unit 201 has a base support 207, which defines a cutting section 208 for supporting the material web 204 during the division of the strip 203, and a supporting section 209, the supporting section 209 being formed and arranged in such a way that it supports the cut material web 212 and the strip 203 as it is transported away out of the cutting section 208 in the transport direction 205. In practical terms in the present case, this means that the supporting section 209 is arranged after the cutting section 208 in the transport direction 205.

The cutting section 208 has a jet opening 210 for the passage of the cutting jet 206.

Furthermore, in the region of the jet opening 210, as in the known cutting device 1, a pipe 211 is provided on the side of the base support 207 facing away from the material web 204, 212, said pipe being formed and arranged in such a way that the cutting jet 206 and cut material are intercepted by said pipe.

In the case of the cutting device 201 according to the invention, the supporting section 209 also has a transport surface 218 that moves in the transport direction 205 and is formed by the upper side of a circulating transport belt 219, which is formed and arranged in such a way that the cut material web 212 and/or the strip 203 is/are carried along, at least in some sections, on the transport surface 218 the transport direction 205 as it is transported away out of the cutting section 208.

In the region between the cutting section 208 and the transport surface 218, the supporting section 209 is configured as a horizontal plate 214 having a cutout 217 formed as an opening, the opening 217 extending in the transport direction 205 from the jet opening 210 as far as the transport surface 219. In this way, in the region between the jet opening 210 and the transport surface 218, disruptions of the transport of the cut material web 212 by deposits of cut material can be prevented, since the opening 217 is arranged and formed in such a way that the cut edge 215 of the material web 212 and/or the cut edge 216 of the strip 203 are not supported on this section of the supporting section 209 during transport away out of the cutting section 208.

The speed of the transport belt 219 corresponds substantially to the speed of the material web 204, 212, which means that it is possible both to carry deposits of cut material away from the base support 207 and also to carry the cut material web 212 and the strip 203 along. Were the transport belt 219 designed to carry the deposits of cut material away out of the region of the base support 207 without carrying the cut material web 212 and the strip along, it would also be sufficient if the transport surface formed as transport belt 219 were to move at a lower speed than the speed of the material web 204, 212.

Furthermore, the transport belt 219 is assigned a duct 213, which is arranged relative to the transport belt 219 in such a way that the strip 203 is fed to the duct 213 from the transport surface 218. As can be seen from FIG. 3, in this case the separation region 221 is formed by the section of the upper side of the transport belt 219 which is currently deflected around the leading deflection roller 222 in the transport direction 205, by which means the strip 203 is separated from the cut material web 212 and fed to the duct 213, whereas the cut material web 212 is carried onward in the original transport direction 205.

Furthermore, a cleaning device 220 formed as a doctor can be seen, which cleans the upper side 218 of the transport belt 219 at a position at which no material web 212 or strip 203 is being carried on said transport belt.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present extends to all functionally equivalent structures, methods and uses, such as are within the scope of the appended claims.

1-26. (canceled)

27. A cutting device comprising:
a cutting unit, the cutting unit dividing a strip from a material web moving in a transport direction relative to the cutting device;
a base support, the base support defining a cutting section for supporting the material web during the division of the strip; and
a transport surface, the transport surface movable relative to the cutting section and arranged after the cutting section in the transport direction.

28. The cutting device of claim 27, wherein the base support defines a supporting section arranged after the cutting section in the transport direction which is formed and arranged in such a way that it supports at least one of the cut material web and the strip as it is transported away from the cutting section in the transport direction, the transport surface being arranged in the region of the supporting section.

29. The cutting device of claim 27, wherein the transport surface is movable in the transport direction and is formed and arranged in such a way that at least one of the cut material web and the strip are carried along on the transport surface in the transport direction in at least one predetermined section.

30. The cutting device of claim 27, wherein the transport surface is formed and arranged in such a way that the cut material accumulating during the cutting of the material web can be deposited on the transport surface and that the transport surface is movable in such a way that the cut material is carried away out of the region of the interaction with at least one of the cut material web and the strip.

31. The cutting device as claimed in claim 30, wherein the transport surface is movable in at least one of the transport direction, counter to the transport direction and transversely with respect to the transport direction.

32. The cutting device of claim 27, wherein the transport surface moves at a first speed and the material web moves at a second speed, and wherein the first speed of the transport surface corresponds substantially to the second speed of the material web.

33. The cutting device of claim 27, wherein the transport surface is a circumferential surface of a rotating roll.

34. The cutting device of claim 27, wherein the transport surface is formed by an upper side of a circulating transport belt.

35. The cutting device of claim 27, wherein the cutting unit further comprises a means for producing a cutting jet, the means for producing the cutting jet aimed at the material web in the cutting section.

36. The cutting device of claim 35, wherein a fluid jet is produced by the means for producing a cutting jet.

37. The cutting device of claim 36, wherein the fluid jet is formed by at least one of a gaseous medium and liquid medium.

38. The cutting device of claim 35, wherein a light beam is produced by the means for producing a cutting jet.

39. The cutting device of claim 35, wherein the cutting section further comprises a jet opening for the passage of the cutting jet.

40. The cutting device of claim 39, wherein a pipe is provided in the region of the jet opening on the side of the base support facing away from the material web, the pipe being formed and arranged in such a way that the cutting jet and cut material are intercepted by said pipe.

41. The cutting device of claim 39, further comprising a cutout, the cutout extending in the transport direction between the jet opening and the transport surface and which is arranged and formed in such a way that the cut edge of at least one of the cut material web and the cut edge of the strip is one of supported and not supported on the supporting section, at least in one section, during transport away out of the cutting section.

42. The cutting device of claim 41, wherein the cutout is formed as an opening in the base support.

43. The cutting device of claim 42, wherein the cutout formed as an opening merges into the jet opening and extends as far as the transport surface.

44. The cutting device of claim 28, wherein the supporting section further comprises a separation region which is formed to separate the strip divided off from the cut material web.

45. The cutting device of claim 44, further comprising a duct, the duct arranged in relation to the separation region in such a way that the separated strip is guided from the separation region into the duct.

46. The cutting device of claim 44, wherein the separation region is formed by a section of the upper side of a transport belt which is being deflected around a leading deflection roller in the transport direction.

47. The cutting device of claim 44, wherein the separation region is formed by a part of the circumferential surface of a roll leading in the transport direction.

48. The cutting device of claim 27, further comprising a cleaning device, by means of which the part of the transport surface not carrying at least one of any strip and any material web can be cleaned.

49. The cutting device of claim 48, wherein the cleaning device is formed as at least one of a doctor, a brush and a fluid jet cleaning device.

50. The cutting device of claim 27, wherein the material web is one of a fibrous web, a paper web, a board web and a tissue web.

51. The cutting device of claim 27, wherein the transport direction of the material web is parallel to the longitudinal extent of the latter.

52. A machine for the production and/or finishing of a fibrous web, having a cutting device of claim 27.
